(19) United States
(12) Patent Application Publication
(10) Pub. No.: US 2015/0017403 A1
(43) Pub. Date: Jan. 15, 2015

(54) CURABLE AND PATTERNABLE INKS AND METHOD OF PRINTING

(71) Applicant: Dow Corning Korea Ltd., SEOUL (KR)

(72) Inventors: Daesup Hyun, Kyunggido (KR); Il Yong Lee, Ch'Ungch'Ong-Bukto (KR)

(21) Appl. No.: 14/376,883

(22) PCT Filed: Feb. 5, 2013
(86) PCT No.: PCT/US13/24727

§ 371 Date: Aug. 6, 2014

Related U.S. Application Data
(60) Provisional application No. 61/596,316, filed on Feb. 8, 2012.

(51) Int. Cl. C09D 11/102; H01B 1/20; H01B 13/00; C08K 5/13; C08K 5/101

(52) U.S. Cl. CPC C09D 11/102; C08K 5/13; C08K 5/101; H01B 13/0026; H01B 13/0016; H01B 1/20
USPC 428/201; 524/317; 427/123

(57) ABSTRACT

A curable and patternable ink, a method of using this ink as part of a structure that performs a function in an electronic device, and a soft lithographic method for forming said structure on a substrate for use within the electronic device is disclosed. The curable and patternable ink generally comprises a first portion defined by structural units of (R)SiO_{3/2}; a second portion defined by structural units of (R)₂SiO_{2/2}; and an organic solvent. Alternatively, the ink further comprises structural units (R)₃SiO_{1/2} or SiO_{4/2}. The R group is independently selected to be an aryl group, a methyl group, or a cross-linkable group with the number of aryl groups being present in an amount that ranges from at least one aryl group up to 20 mole %. The patternable ink may be applied to a substrate using a soft lithographic process with good reproducibility of the applied pattern.

This disclosure relates generally to curable and patternable materials for use in electronic devices, such as ultra-large scale interconnect (ULSI) structures. More specifically, this disclosure relates to patternable dielectric and conductive inks, the use of these inks in the structure of an electronic device and a method of forming said structure via a soft lithographic process.

Photolithography is process that can provide submicron-sized patterned features that serve as a template for the etching and deposition of functional thin films during the production of electronic circuitry. The general process associated with forming a structure using this technique involves multiple steps as depicted in FIG. 1. These steps include spin coating, baking, UV-exposure, post-baking, developing, hard-baking, and metallization. Due to the number of process steps and the type of materials and equipment involved in each step, the ability to provide patterned features using this method is very expensive and, therefore, not cost effective for many applications.

Soft lithographic processes provide an alternative printing and patterning technique. Soft lithography generally involves a patterning process that uses non-light sensitive chemicals and a non-photo mask with a variety of different patterning techniques, such as printing, stamping, molding or embossing. The most common material used in soft lithography as the means through which patterns are transferred during the process is a block of polydimethylsiloxane (PDMS). Several of the types of patterning techniques used in soft lithography include micro-contact printing (μCP), micro-molding in capillaries (MIMIC), replica molding (REM), micro-transfer molding (μTM), solvent assisted micro-molding (SAMM), and decal transfer microlithography (DTM). A more complete discussion of various soft lithographic processes used for the deposition of thin films is provided in U.S. Patent Publication 2007/0166479A1. Unfortunately, conventional soft lithographic processes suffer from problems associated with the reproducibility of patterned features.

### BRIEF SUMMARY OF THE INVENTION

In satisfying the above need, as well as overcoming the enumerated drawbacks and other limitations of the related art, the present invention generally provides a curable and patternable ink, along with a method of using the ink as part of a structure that performs a function in an electronic device. In addition, the present invention also provides a soft lithographic method of forming said structure on a substrate for use within the electronic device.

According to one aspect of the present disclosure, a soft lithographic method of forming a structure on a substrate for use in an electronic device is provided. This method generally comprises the steps of printing a patternable ink onto the surface of the substrate in a predetermined pattern to form a patterned ink layer, curing the patterned ink layer; metalizing at least a portion of the surface of the patterned ink layer; and forming a structure on the substrate capable of performing a function in the electronic device. The patternable ink comprises an aryl functionalized resin component dispersed in an organic solvent, such that the aryl functionalized resin component includes a predetermined combination of curable aryl functionalized silsesquioxane resins and linear aryl functionalized polysiloxanes. Alternatively, the aryl groups are phenyl groups, tolyl groups, xylyl groups, naphthyl groups, or mixtures thereof. The patternable ink may also further comprise at least one of a cure accelerator or catalyst, a low molecular weight cross-linker, an adhesion promoter, and an inhibitor.

The step of printing the patternable ink may comprise the use of roll printing, micro-contact printing, or nano-imprinting techniques. The performance of these techniques basically involves transferring the patternable ink onto the surface of a polydimethylsiloxane (PDMS) layer; forming the patterned ink layer on the PDMS layer; drying or gelling the interface between the patterned ink layer and the PDMS layer; bringing the patterned ink layer in contact with the surface of a substrate; and transferring the patterned ink layer from the PDMS layer to the surface of the substrate.

The drying or gelling of the interface is facilitated by absorption of the organic solvent of the patternable ink into the PDMS layer, while the transferring of the patterned ink layer from the PDMS layer to the surface of the substrate is facilitated by an incompatibility between the patterned ink layer and the PDMS layer. In general, this incompatibility represents a difference in surface energy exhibited by the patterned ink layer and the PDMS layer. More specifically, the surface energy exhibited by the patterned ink layer is higher than the surface energy exhibited by the PDMS layer. This difference in surface energy between the patterned ink layer and the PDMS layer is caused by the aryl functionalized resin component in the patternable ink comprising at least one aryl group up to approximately 20 mole % of aryl groups relative to the resin component. The curing of the patterned ink layer is generally accomplished via a hydrosilylation, hydrogenative coupling, or hydrolysis and condensation pathway.

According to another aspect of the present disclosure, an electronic device is provided that comprises a substrate; a cured ink layer located proximate to the surface of the substrate in a predetermined pattern; and at least one metallization layer. The cured ink layer comprises an aryl resin layer defined by T^{R}, D^{RR}, M^{RRR}, and Q structural units according to the formula:

(T^{R})ₐ(D^{RR})_{b}(M^{RRR})_{c}(Q)_{d}

where (T^{R})ₐ represents structural units of (R)SiO_{3/2}; (D^{RR})_{b} represents structural units of (R)₂SiO_{2/2}; (M^{RRR})_{c} represents structural units of (R₃)SiO_{1/2}; and (Q)_{d} represents structural units of SiO_{4/2}, such that each R group is independently selected to be an aryl group; and the subscripts (a-d) represent the mole fraction of each structural unit according to the relationship (a+b+c+d)=1 with the subscripts (a) and (b) being greater than zero. The aryl groups are present in the aryl resin layer in an amount ranging from one aryl group up to approximately 20 mole % relative to the resin molecule. Alternatively, the aryl groups are phenyl groups.

The electronic device may be an ultra-large scale interconnect structure (ULSI), a plasma display panel (PDP), a thin film transistor liquid crystal display (TFT-LCD), a semiconductor device, a printed circuit board (PCB), or a solar cell. The electronic device may further comprise at least one of an encapsulation layer, a passivation layer, a solder bump, or a wire such that the cured ink layer reduces stress induced by the incorporation of the metallization layer or the solder bump into the structure.

According to yet another aspect of the present disclosure, a curable and patternable ink for use in forming a structure in an electronic device is provided. The curable and patternable ink generally comprises a first portion defined by structural units of (R)SiO_{3/2}; a second portion defined by structural units of (R)₂SiO_{2/2}; and an organic solvent. Alternatively, the patternable ink further comprises a third portion defined by structural units of (R)₃SiO_{1/2} and/or a fourth portion defined by structural units of SiO_{4/2}. The R group is independently selected to be an aryl group, a methyl group, or a cross-linkable group with the number of aryl groups being present in an amount that is between one aryl group and approximately 20 mole % of aryl group relative to the patternable ink. The aryl groups are selected as phenyl groups, tolyl groups, xylyl groups, naphthyl groups, or mixtures thereof. The cross-linkable group is selected as a vinyl, Si—H, silanol, or alkoxy moiety that is capable of undergoing a hydrosilylation, hydrogenative coupling, or hydrolysis/condensation reaction. Alternatively, the curable and patternable ink further comprises at least one of a cure accelerator or catalyst, a low molecular weight cross-linker, an adhesion promoter, a conductive filler, a nonconductive filler, or an inhibitor.

The organic solvent in the curable and patternable ink has a boiling point greater than 130° C. The organic solvent may be selected to be diethylene glycol methyl ethyl ether propylene carbonate, propylene glycol methyl ether acetate, carbitol acetate, diethylene glycol ethyl ether or carbitol, ethyl lactate, r-butyrolactone, n-methyl 2-pyrrolidinone (NMP), n-butyl carbitol or a mixture thereof.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic representation of a conventional photolithographic process;

FIG. 2 is a cross-sectional view of an ultra-large scale interconnect (ULSI) constructed with a patternable ink according to the teachings of the present disclosure;

FIG. 3 is a schematic representation of a method describing the use of the patternable ink in a soft lithography process highlighting the printing step of the method;

FIG. 4 is a schematic representation of a roll printing process used to apply the patternable ink according to the teachings of the present disclosure;

FIG. 5A is a photomicrograph of a printed pattern applied to a substrate according to the teachings of the present disclosure after ten printing passes observed using microscopic and 3-D microscopic techniques;

FIG. 5B is a photomicrograph of a printed pattern applied to a substrate according to the teachings of the present disclosure after greater than 100 printing passes observed using microscopic and 3-D microscopic techniques; and

FIG. 6 is a schematic representation describing the use of the patternable ink in a soft lithography process highlighting 3-D nano-imprinting.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

The present disclosure generally provides curable, patternable inks used in the fabrication of an electronic device exemplified by ultra-large scale interconnect (ULSI) structures. Alternatively, the present disclosure provides patternable inks suitable for reducing the stress induced by the metallization or solder bump incorporated into the structure. These patternable inks are preselected to be dielectric or conductive in nature and generally comprise a curable, aryl functionalized resin component dispersed in a solvent. Alternatively, the patternable ink further comprises at least one of a cure accelerator (e.g., catalyst), a low molecular weight cross-linker, or other additives, such as adhesion promoters, conductive fillers, and inhibitors. As used herein, the aryl groups present in the aryl functionalized resin component may, include, but not be limited to, phenyl groups, tolyl groups, xylyl groups, naphthyl groups, and mixtures thereof. Alternatively, the aryl groups present in the resin component are phenyl groups.

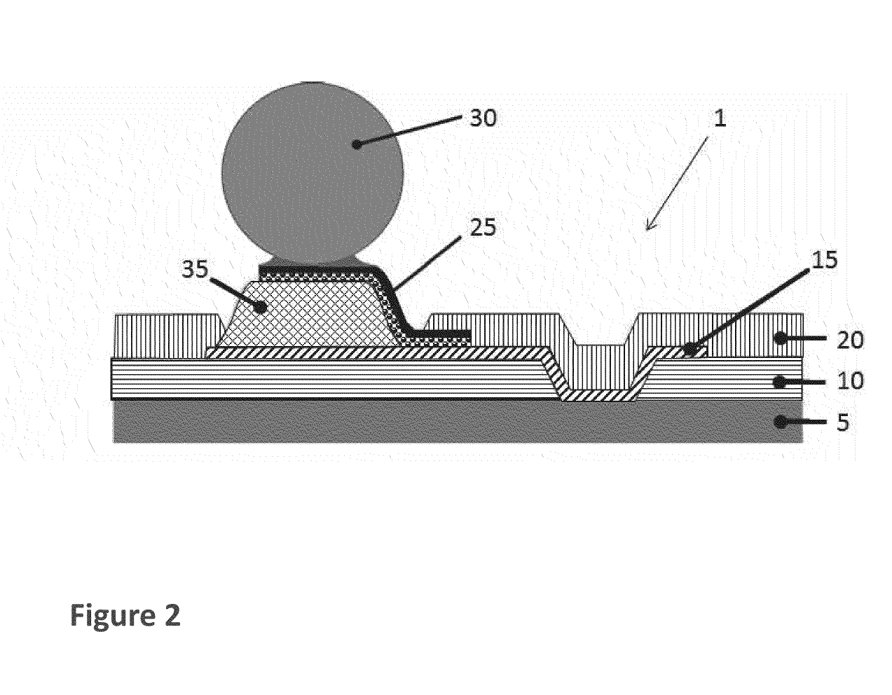

Referring to FIG. 2, one example of using the curable, patternable inks of the present disclosure in the construction of a ULSI structure is shown. One skilled in the art will understand that the patternable inks may be used in many electronic devices including, but not limited to, plasma display panels (PDP), thin film transistor liquid crystal displays (TFT-LCD), semiconductor devices, printed circuit boards (PCB), and solar cells, without exceeding the scope of the present disclosure. However, throughout this disclosure, the use of patternable inks in the construction of a ULSI structure is described in order to more fully illustrate the inks and provide an example of their use. The use of such an illustrative example is not intended to limit the use of these inks in other applications.

In the representative example shown in FIG. 2, a ULSI structure 1 comprises a silicon wafer or chip 5 upon which subsequent primary passivation 10, copper trace 15, secondary passivation 20, and Ti/Cu/Ni metallization 25 layers are formed. A solder ball 30 is placed in contact with metallization layer 25 in order to be coupled to an external wire. In this specific example, the patternable ink 35 of the present disclosure acts as a dielectric and is provided between the copper trace 15 and the metallization layer 25 in order to provide support for the solder ball 30.

The aryl functionalized resin component generally comprises a predetermined combination of aryl functionalized silsesquioxane (SSQ) resins, and linear aryl functionalized polysiloxanes. Aryl functionalized SSQ resins and aryl functionalized polysiloxanes typically undergo crosslinking reactions, including but not limited to, hydrosilylation, hydrogenative coupling, or hydrolysis/condensation. Thus these aryl SSQ resins and aryl polysiloxanes may incorporate one or more of vinyl functionality, Si—H, silanol, and/or alkoxy functionality in order to undergo crosslinking via a catalyzed hydrosilylation, hydrogenative coupling, or hydrolysis and condensation pathway. The aryl functionalized resin component may also include low molecular weight cross-linkable molecules, including but not limited to aryl rich Si—H cross-linkers, to facilitate such crosslinking reactions. The patternable inks include a predetermined number of aryl groups in order to prevent the migration of the ink into the polydimethylsiloxane (PDMS) layer or block used in a soft lithographic process.

The aryl functionalized resin component in the patternable ink comprises a first portion defined by structural units of (R)SiO_{3/2} and a second portion defined by structural units of (R)₂SiO_{2/2}. Alternatively, the aryl functionalized resin component may further comprise a third portion defined by structural units of (R)₃SiO_{1/2}. The aryl functionalized resin may optionally include yet a fourth portion defined by structural units of SiO_{4/2}. The aryl functionalized resin component may have a molecular weight within a range whose lower limit is 1000, alternatively 2000, or alternatively 3000 grams/mole, and the upper limit is 10,000, alternatively 15,000, or alternatively 20,000 grams/mole.

The R group is independently selected to be an aryl group, a methyl group, or a cross-linkable group with the number of aryl groups being predetermined to ensure that incompatibility between the ink and the PDMS substrate used in the printing process exists. The predetermined number of aryl groups present in the aryl functionalized resin component may range from at least one aryl group up to about 20 mole % of the cured patternable ink; alternatively up to about 15 mole %; alternatively up to about 10 mole %.

Crosslinking within the aryl functionalized resin component may be induced by at least one of the R groups in the resin component being a cross-linkable moiety, such as a vinyl, Si—H, silanol, or alkoxy moiety in order for the ink to undergo crosslinking via a hydrosilylation, hydrogenative coupling, or hydrolysis/condensation reaction. Crosslinking may also be induced in the aryl functionalized resin component through the addition of a low molecular weight, aryl rich cross-linker molecule, such as a phenyl rich, Si—H cross-linker (e.g., dimethyl hydrogen terminated phenyl silsesquioxane) to the curable, patternable ink. Such cross-linking reactions occur during the thermal cure or baking step associated with a soft lithographic process.

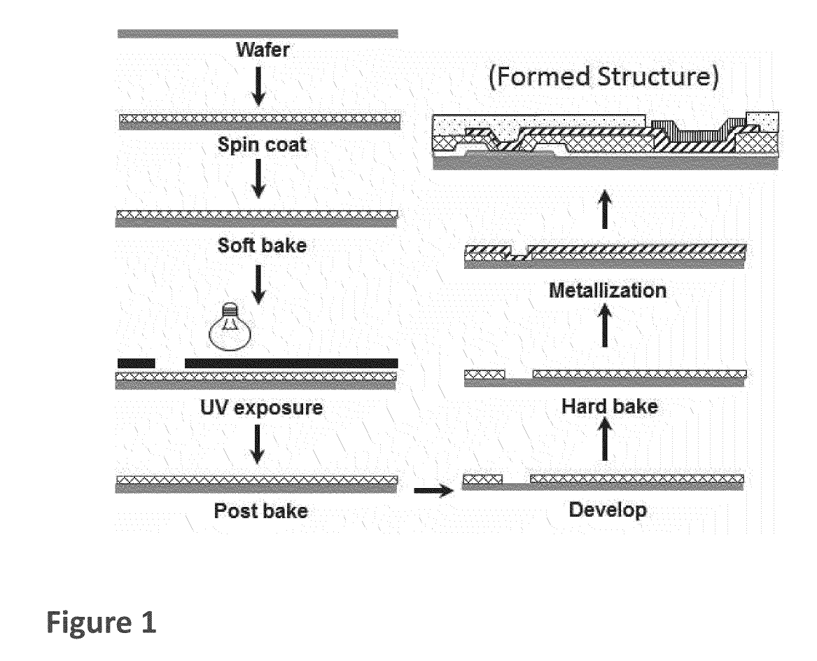

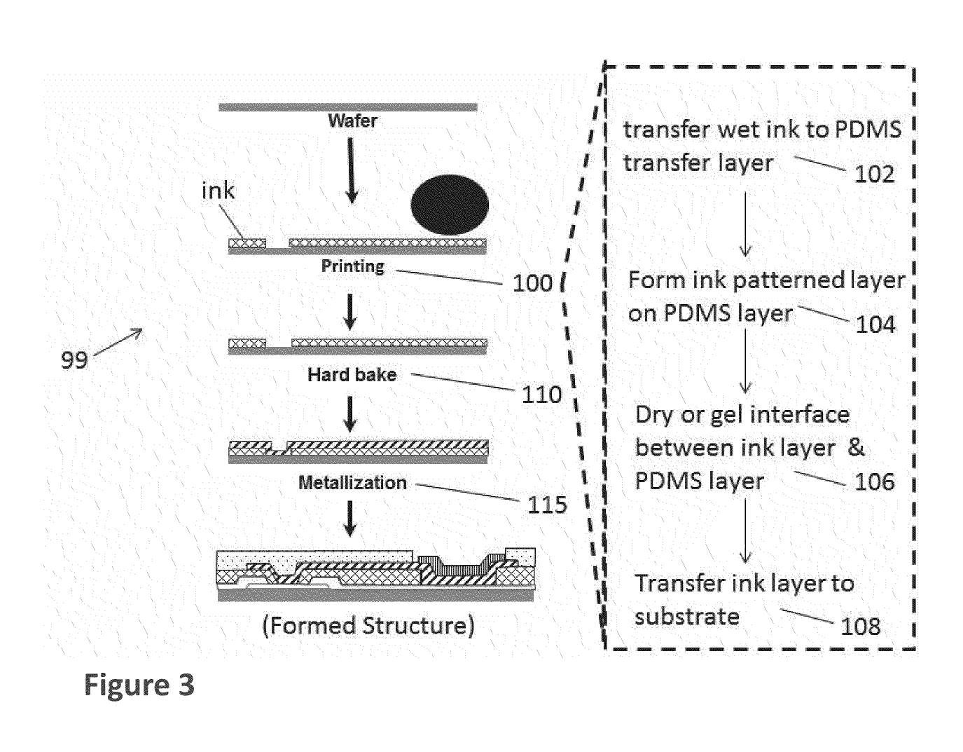

According to another aspect of the present disclosure, the curable, patternable inks are applied in a pattern to a substrate using a soft lithographic process 99 as shown in FIG. 3. Within the soft lithographic process 99, the inks are applied in a pattern using a printing process 100, such as roll printing, micro-contact printing, or nano-imprinting techniques in which a PDMS blanket or roll acts as a transfer medium. Subsequently, the patterned inks are thermally cured by hard baking 110, followed by metallization 115 in order to form a finished structure or device. The hard baking 110 is intended to enhance the etch resistance of the patterned inks by hardening the surface of the ink upon exposure to temperatures greater than about 70° C.; alternatively greater than about 95° C.; alternatively greater than about 110° C. The metallization 115 may be applied onto the hardened surface of the ink using sputtering, chemical vapor deposition (CVD), thermal evaporation, molecular beam epitaxy (MBE), or any other chemical, electrochemical, or ion-assisted technique, among others, The number of steps in such a soft lithographic process 100 is substantially smaller than the number of steps required in photolithography (see FIG. 1) to produce a similar structure. Thus a soft lithographic process used with the patternable inks of the present disclosure is a more cost effective process than conventional photolithography.

Still referring to FIG. 3, the process for applying the inks in a pattern to a substrate in the printing step 100 of a soft lithography process 99 generally includes the steps of: transferring 102 the wet ink to a PDMS transfer layer or medium; forming 104 an ink patterned layer on the surface of the PDMS transfer layer; drying or gelling 106 the interface between the ink layer and the PDMS transfer layer; and transferring 108 the patterned ink layer to a substrate. The drying or gelling 106 of the interface can be accomplished by allowing the solvent in the applied ink layer to be absorbed into the PDMS transfer layer. The absorption of the solvent may cause the PDMS layer to swell. The incompatibility between the aryl functionalized resin component in the patternable ink and the PDMS transfer layer assists in the transfer 108 of the ink to the substrate.

Polydimethylsiloxane (PDMS) is used for the transfer layer or medium because of its low surface energy and release capability for the patternable ink. Resins used in the patternable ink layer, which include a predetermined amount of aryl functionality, are incompatible with the PDMS transfer layer. By incompatibility, reference is being made to the chemical and physical properties of each layer being such that the layers do not adhere to one another, such that the layers may be separated from one another when desired. For example, the ink layer exhibits a higher surface energy than PDMS. This difference in surface energy allows the ink to be released from the surface of the PDMS layer during the printing process.

Still referring to FIG. 3, the curable, patternable ink is applied or transferred 102 to the surface of the substrate in liquid form due to the presence of an organic solvent or carrier in the ink. The organic solvent may be any solvent having a boiling point (Bp) above about 130° C. and is compatible with the PDMS layer used in the printing process. In other words, the solvent is capable of being absorbed into the PDMS layer. Examples of several organic solvents suitable for use in the patternable ink include, but are not limited to, diethylene glycol methyl ethyl ether (Bp=176° C.), propylene carbonate (Bp=242° C.), propylene glycol methyl ether acetate (Bp=146° C.), carbitol acetate (Bp=219° C.), diethylene glycol ethyl ether or carbitol (Bp=196° C.), ethyl lactate (Bp=154° C.), r-butyrolactone (Bp=204° C.), n-methyl 2-pyrrolidinone or NMP (Bp=202° C.), n-butyl carbitol (Bp=231° C.), and mixtures thereof.

Once the curable ink is transferred 102 to the surface of the PDMS layer, an ink layer is formed 104. The absorption of the solvent from the ink layer into the PDMS layer assists in the “drying” or “gelling” 106 of the ink layer at the interface between this layer and the PDMS layer. The properties exhibited by PDMS layers that are generally used as a transfer medium are described in more detail in Table 1(A-B). More specifically, the PDMS layer exhibits a hardness value on the order of about 20-30 Shore A, a tensile stress between about 2.4×10⁵-5.5×10⁶ Pa (35-800 psi), and an elongation factor in excess of 200%. The PDMS layer is highly acceptable to the absorption of organic solvents, such as terpineol, methylethyl carbitol, and carbitol acetate. Upon the absorption of the solvent from the ink layer by the PDMS layer, the dried or gelled ink layer is then capable of being transferred 108 to substrates, such as for example, glass or wafers. Once transferred 108 to the surface of the substrate, the dried or gelled ink layer may be cured by hard baking 110.

TABLE 1(A - B)
Properties of PDMS Layer used in Printing Process Step.
A

| PDMS Blanket | Hardness | Tensile Stress | Elongation |
|---|---|---|---|
| Properties | (Shore A) | (Pa) | (%) |
| XR-3006 | 32 | 5.40 × 10⁶ | 243 |
| XR-3007 | 27 | 3.55 × 10⁶ | 282 |
| XR-3013 | 20 | 2.72 × 10⁶ | 263 |

B

| Solvent | Terpineol | Methyl ethyl | Carbitol |
|---|---|---|---|
| Absorption | (%) | carbitol (%) | acetate (%) |
| XR-3006 | 7.6 | 30.5 | 8.8 |
| XR-3007 | 6.4 | 24.5 | 6 |
| XR-3013 | 6.7 | 28.4 | 6.4 |

According to yet another aspect of the present disclosure, upon hard baking 110 the patternable ink, an aryl resin layer is formed that comprises T^{R}, D^{RR}, M^{RRR}, and Q structural units according to the formula (F-1):

(TR)ₐ(DRR)_{b}(M^{RRR})_{c}(Q)_{d} (F-1)

wherein (T^{R})ₐ represents structural units of (R)SiO_{3/2}; (D^{RR})_{b} represents structural units of (R)₂SiO_{2/2}; (M^{RRR})_{c} represents structural units of (R)₃SiO_{1/2}; and (Q)_{d} represents structural units of SiO_{4/2}. Each R group is independently selected to be an aryl group, alternatively each R group is a phenyl group; and the subscripts (a-d) represent the mole fraction of each structural unit according to the relationship (a+b+c+d)=1 with the subscripts (a) and (b) being greater than zero.

The following specific examples are given to illustrate the disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure.

### Example 1

### Preparation of a Curable and Patternable Ink

One specific example, among many, of a patternable ink prepared according to the teachings of the present disclosure comprises an aryl functionalized resin component that includes structural units defined by a mixture of a phenyl (Ph) silsesquioxane (SSQ) resin as stored in a carbitol acetate solvent, a phenyl (Ph) linear polysiloxane, fumed silica, and a phenyl (Ph) rich, Si—H cross-linker. The SSQ resin provides structural units of (Ph)SiO_{3/2}; the linear polysiloxane provides structural units of (Ph)₂SiO_{2/2}; the phenyl rich cross-linker provides structural units of (Ph)₃SiO_{1/2}; and the fumed silica provides structural units of SiO_{4/2}. The aryl functionalized resin component is combined and mixed with a platinum catalyst, an adhesion promoter, and an inhibitor in a propylene glycol phenyl ether solvent. More specific information regarding the various amounts of the different resins, additives, and solvents that are combined to form the patternable ink formulation is provided in Table 2. The patternable ink is stored until applied to a substrate via a printing process.

TABLE 2
Curable and Patternable Ink Formulation

| COMPOSITION | wt. % |
|---|---|
| Dimethylvinylsiloxy-terminated | 60.5 |
| phenylsilsesquioxane in 24% | |
| carbitol acetate | |
| Methyl-3-glycodoxypropylsiloxane | 3 |
| with dimethylvinylsiloxy- | |
| terminated phenylsilsesquioxane | |
| Dimethylvinylsiloxy-terminated | 6.845 |
| methylphenylsiloxane | |
| Dimethylhydrogen-terminated | 5.6 |
| phenylsilsesquioxane | |
| Rheolosil ® MT-10C fumed silica | 4 |
| (Tokuyama Corporation) | |
| Propylene glycol phenyl ether | 20 |
| Methyl(tris(1-1dimethyl-2- | 0.04 |
| propynyloxy))silane | |
| 1,3-Diethenyl-1,1,3,3,-tetramethyl- | 0.015 |
| disiloxane platinum complex | |

### Example 2

### Printing Patternable Ink Via Roll Printing

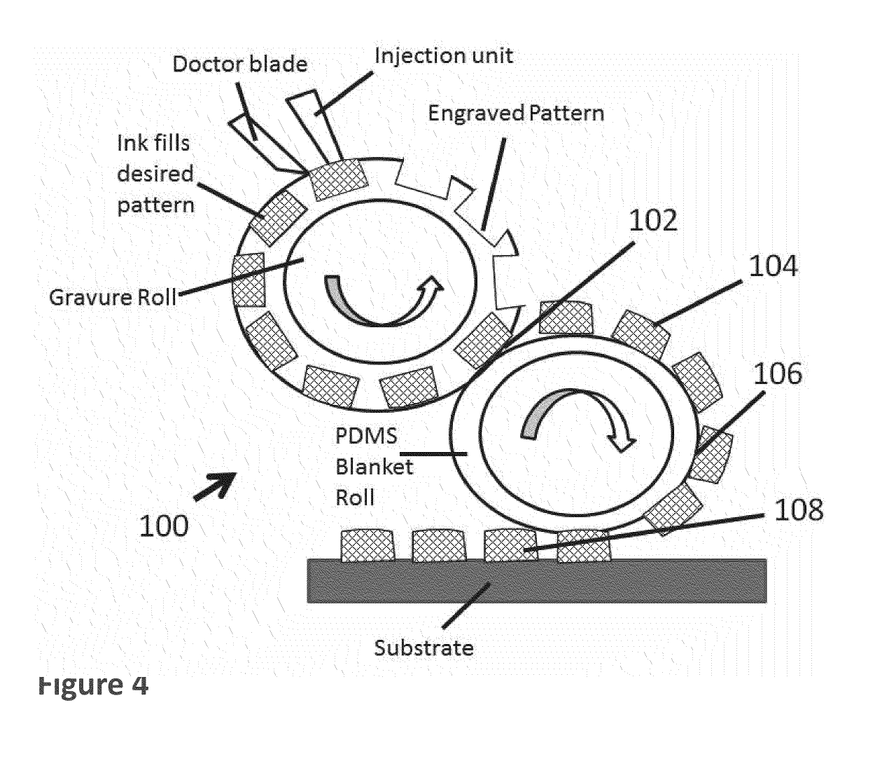

In this Example, the patternable ink of Example 1 is applied to a substrate in a printing process 100 that is a form of roll printing known as Gravure Offset printing. Referring now to FIG. 4, in this printing step 100, the patternable ink is applied to the surface of a gravure roll through the use of an ink injection unit, such as a roll or ink jet. In this technique, the desired pattern for the ink is engraved into the surface of the gravure roll. The patternable ink fills the troughs in the surface of the gravure roll that constitutes the engraved pattern. A doctor blade is used to remove any excess ink that is not needed to fill the engraved pattern. The rotation of the gravure roll causes the ink filled engraved pattern to contact a blanket roll in which the outer surface of the roll comprises polydimethylsiloxane (PDMS). Thus the wet ink is transferred 102 in the form of the engraved pattern from the gravure roll to the PDMS blanket roll. Once transferred the wet ink forms 104 a patterned ink layer on the surface of the PDMS blanket roll. The absorption of the solvent from the patternable ink into the PDMS blanket roll causes the interface between the ink layer and the PDMS blanket roll to dry or gel 106. The rotation of the PDMS blanket roll causes the ink layer to contact a substrate upon which the ink layer is transferred 108 from the PDMS blanket roll to the substrate.

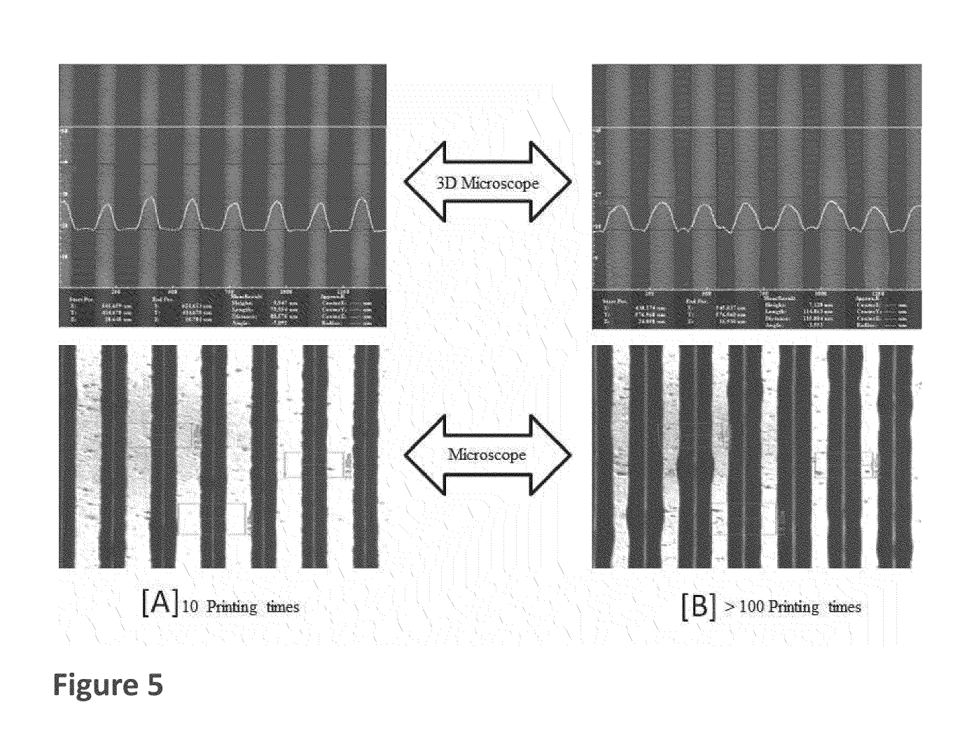

Referring now to FIGS. 5 (A & B), images of the patternable ink applied in a pattern to a substrate are shown using both a normal microscope and a 3-D microscope. The thickness of the printed pattern can be increased by going through the printing process multiple times as demonstrated by comparing the 3-D microscopic images shown in FIG. 5A in which 10 printing cycles is utilized and FIG. 5B in which greater than 100 printing cycles are utilized. This example demonstrates the reproducibility of the desired pattern using the patternable inks in a soft lithographic process.

### Example 3

### Soft Lithographic Process with Printing of Patternable Ink Using a 3-D Nano-Imprinting Step

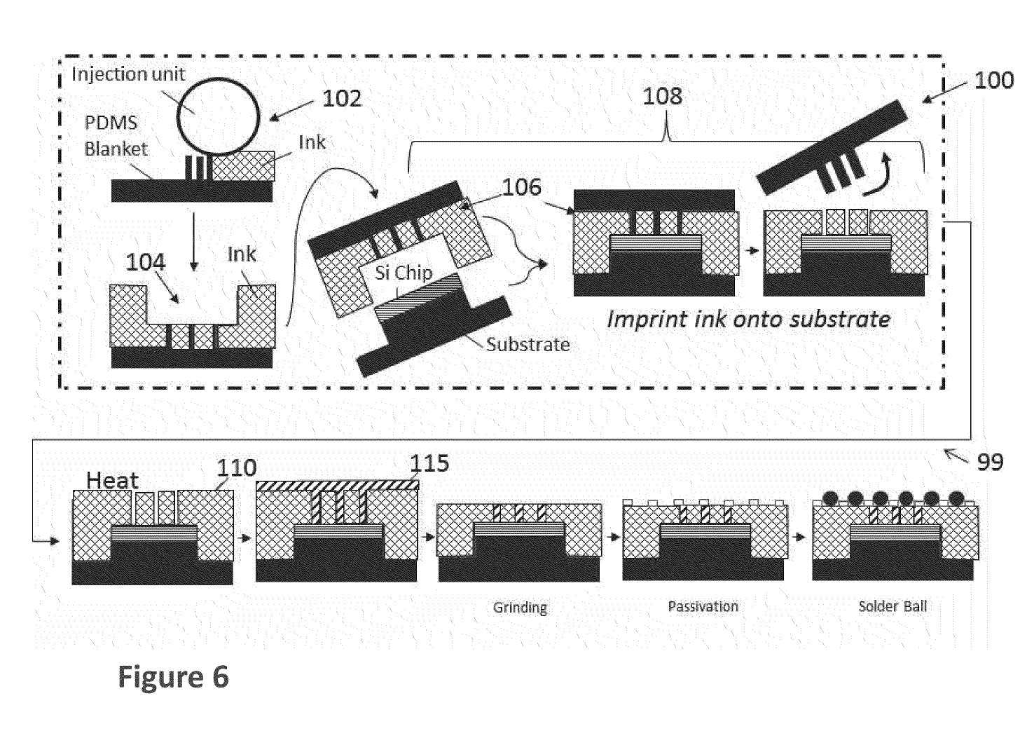

In this Example, the patternable ink of Example 1 is applied during the construction of an electronic device via soft lithography 99 using a printing process 100 known as 3-D nano-imprinting. Referring now to FIG. 6, in the printing step 100, the patternable ink is applied to the surface of a PDMS blanket or sheet. The PDMS sheet can be molded or constructed such that the desired pattern is provided on the sheet similar to an engravement done on a gravure roll as described in Example 2. Alternatively, the PDMS sheet can be flat or smooth and the ink applied directly to the PDMS sheet in the desired pattern. The patternable ink may be applied to the surface of the PDMS sheet 102 using any type of injection unit, including but not limited to roll printing and ink jet printing. Once transferred, the wet ink forms 104 a patterned ink layer on the surface of the PDMS blanket or sheet. The absorption of the solvent from the patternable ink into the PDMS sheet causes the interface between the ink layer and the PDMS sheet to dry or gel 106. The pressing of the PDMS sheet and patterned ink layer to the surface of the substrate causes the ink layer to contact the substrate upon which the ink layer is transferred 108 from the PDMS sheet to the substrate.

Once the patterned ink becomes imprinted onto the surface of the substrate, subsequent steps in the photolithographic process 99 can take place, including but not limited to hard baking 110 and metallization 115. Alternatively, additional steps may be performed, such as grinding, passivation, and application of solder balls.

A person skilled in the art will recognize that the measurements described are standard measurements that can be obtained by a variety of different test methods. The test methods described in the examples represents only one available method to obtain each of the required measurements.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A soft lithographic method of forming a structure on a substrate for use in an electronic device, the method comprising the steps of:
printing a patternable ink onto the surface of the substrate in a predetermined pattern to form a patterned ink layer; the patternable ink comprising an aryl functionalized resin component dispersed in an organic solvent and optionally one or more additional components selected from a cure accelerator, a catalyst, a low molecular weight crosslinker, an adhesion promoter, and an inhibitor; the aryl functionalized resin component including a predetermined combination of curable aryl functionalized silsesquioxane resins and linear aryl functionalized polysiloxanes;
curing the patterned ink layer; the cured patterned ink layer comprising an aryl resin layer defined by T^{R}, D^{RR}, M^{RRR}, and Q structural units according to the formula (F-1):
(T^{R})ₐ(D^{RR})_{b}(M^{RRR})_{c}(Q)_{d} (F-1)
where (T^{R})ₐ represents structural units of (R)SiO_{3/2}; (D^{RR})_{b} represents structural units of (R)₂SiO_{2/2}; (M^{RRR})_{c} represents structural units of (R)₃SiO_{1/2}; and (Q)_{d} represents structural units of SiO_{4/2}, such that each R group is independently selected to be an aryl group; and the subscripts (a-d) represent the mole fraction of each structural unit according to the relationship (a+b+c+d)=1 with the subscripts (a) and (b) being greater than zero;
applying a metallization layer to at least a portion of the surface of the cured patterned ink layer; and
forming a structure on the substrate capable of performing a function in the electronic device.

2. The method according to claim 1, wherein the aryl group is selected from phenyl groups, tolyl groups, xylyl groups, naphthyl groups, or mixtures thereof.

3. The method according to claim 1, wherein the step of printing a patternable ink onto the surface of a substrate further comprises the steps of:
transferring the patternable ink onto the surface of a polydimethylsiloxane (PDMS) layer;
forming the patterned ink layer on the PDMS layer;
drying or gelling the interface between the patterned ink layer and the PDMS layer;
bringing the patterned ink layer in contact with the surface of the substrate; and
transferring the patterned ink layer from the PDMS layer to the surface of the substrate.

4. The method according to claim 1, wherein the aryl functionalized resin component in the patternable ink comprises at least one aryl group in the amount of up to 20 mole % of the resin component.

5. An electronic device comprising:
a substrate having a surface;
a cured ink layer located proximate the surface of the substrate in a predetermined pattern;
at least one metallization layer; and optionally
one or more of an encapsulation layer, a passivation layer, a solder bump, and a wire;
wherein the cured ink layer comprises an aryl resin layer defined by R^{R}, D^{RR}, M^{RRR}, and Q structural units according to the formula (F-1):
(T^{R})ₐ(D^{RR})_{b}(M^{RRR})_{c}(Q)_{d} (F-1)
where (T^{R})ₐ represents structural units of (R)SiO_{3/2}; (D^{RR})_{b} represents structural units of (R)₂SiO_{2/2}; (M^{RRR})_{c} represents structural units of (R)₃SiO_{1/2}; and (Q)_{d} represents structural units of SiO_{4/2}, such that each R group is independently selected to be an aryl group; and the subscripts (a-d) represent the mole fraction of each structural unit according to the relationship (a+b+c+d)=1 with the subscripts (a) and (b) being greater than zero.

6. The electronic device according to claim 5, wherein the electronic device is an ultra-large scale interconnect structure (ULSI), a plasma display panel (PDP), a thin film transistor liquid crystal display (TFT-LCD), a semiconductor device, a printed circuit board (PCB), or a solar cell.

7. The electronic device according to claim 5, wherein the aryl groups in the cured ink layer are selected from phenyl groups, tolyl groups, xylyl groups, naphthyl groups, or mixtures thereof.

8. The electronic device according claim 5, wherein the aryl groups in the cured ink layer are present in an amount of up to 20 mole % of the resin component.

9. A curable and patternable ink for use in forming a structure in an electronic device, the curable and patternable ink comprising:
a first portion defined by structural units of (R)SiO_{3/2};
a second portion defined by structural units of (R)₂SiO_{2/2}; and
an organic solvent; and optionally one or more additional components selected from a cure accelerator, a catalyst, a low molecular weight crosslinker, an adhesion promoter, a conductive filler, a nonconductive filler, and an inhibitor;
wherein the R group is independently selected to be an aryl group, a methyl group, or a cross-linkable group; and the aryl groups are present in an amount ranging from at least one aryl group up to 20 mole % of the aryl resin.

10. The curable and patternable ink according to claim 9, wherein the ink further comprises a third portion defined by structural units of R₃SiO_{1/2} and, optionally, a fourth portion defined by structural units of SiO_{4/2}.

11. The curable and patternable ink according to claim 9, wherein the aryl groups are phenyl groups, tolyl groups, xylyl groups, naphthyl groups, or mixtures thereof.

12. The curable and patternable ink according to claim 9, wherein the cross-linkable group is a vinyl, Si—H, silanol, or alkoxy moiety capable of undergoing a hydrosilylation, hydrogenative coupling, or hydrolysis/condensation reaction.

13. The curable and patternable ink according to claim 9, wherein the organic solvent has a boiling point greater than 130° C.

14. The curable and patternable ink according to claim 9, wherein the organic solvent is diethylene glycol methyl ethyl ether propylene carbonate, propylene glycol methyl ether acetate, carbitol acetate, diethylene glycol ethyl ether or carbitol, ethyl lactate, r-butyrolactone, n-methyl 2-pyrrolidinone (NMP), n-butyl carbitol, or a mixture thereof.
